(19) United States
(12) Patent Application Publication
(10) Pub. No.: US 2009/0261719 A1
(43) Pub. Date: Oct. 22, 2009

(54) ORGANIC ELECTROLUMINESCENT APPARATUS

(75) Inventors: Toru Nimura, Matsumoto-shi (JP); Masahiro Uchida, Chino-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/415,458

(22) Filed: Mar. 31, 2009

(30) Foreign Application Priority Data
Apr. 21, 2008 (JP) 2008-109878

(51) Int. Cl. H01J 1/63

(52) U.S. Cl. 313/504

(57) ABSTRACT

An organic electroluminescent apparatus includes a first substrate and a second substrate facing each other, a first sealing portion that seals the first and second substrates so as to form a closed space between the first and second substrates, an organic light-emitting element that is disposed on the first substrate in the closed space and includes an organic light-emitting layer mainly composed of an organic light-emitting material, a second sealing portion that is disposed on the organic light-emitting element and seals the organic light-emitting element, and a drying agent film that is formed in a region surrounded by the first and second sealing portions and is mainly composed of a drying agent.

### BACKGROUND

1. Technical Field

The present invention relates to an organic electroluminescent apparatus.

2. Related Art

In recent years, organic electroluminescent apparatuses (organic EL apparatuses) that include light-emitting elements, such as organic electroluminescent elements (organic EL elements), on a substrate have been widely used as display apparatuses and as exposure units in electrophotographic image forming apparatuses

Such organic EL apparatuses must be durable in long-term emission. However, the formation of a dark spot has caused a deterioration in luminescence properties of organic EL elements. In an organic EL element in which a transparent electrode, an organic light-emitting layer that includes a light-emitting layer composed of an organic compound, and a back electrode are sequentially layered, a dark spot is formed when water adsorbed on the surface of a component of the organic EL element or an ambient gas, such as water (moisture) or oxygen, entering the organic EL element enters the layered structure from a defect on the surface of the back electrode to form a void between the organic light-emitting layer and the back electrode.

In such organic EL apparatuses, to improve the reliability and life of an organic EL element, it is important to isolate an organic light-emitting layer and electrodes of the organic EL element from ambient gas. Thus, in one known technique, a substrate (transparent substrate) on which an organic EL element is disposed and a sealing component is integrated using an adhesive, thereby protecting the organic EL element from ambient gas.

For example, Japanese Unexamined Patent Application Publication No. 2001-35659 discloses an organic EL element that includes a transparent ITO anode, an organic light-emitting layer, and an opaque aluminum (Al) back electrode serving as a cathode sequentially layered on a translucent glass substrate. A hollow glass sealing cap (sealing component) is hermetically placed on the substrate with an adhesive to cover the layered structure. The sealing component includes a drying agent disposed opposite the layered structure. The drying agent is composed of a compound that chemically adsorbs water while maintaining a solid state.

However, when the capacity of the drying agent is exceeded, water remaining in the sealing component may react with the organic light-emitting layer, thus causing a dark spot or deterioration of the organic EL element. Furthermore, when a region in which an organic light-emitting layer is formed includes a foreign substance, a back electrode may not fully cover the organic light-emitting layer. The resulting exposed portion of the organic light-emitting layer may cause a dark spot due to moisture in a short period of time.

### SUMMARY

The present invention has been achieved to solve at least part of the problems described above and can be implemented in accordance with the following embodiments or aspects.

[Aspect 1] An organic EL apparatus that includes a first substrate and a second substrate facing each other, a first sealing portion that seals the first and second substrates so as to form a closed space between the first and second substrates, an organic light-emitting element that is disposed on the first substrate in the closed space and includes an organic light-emitting layer mainly composed of an organic light-emitting material, a second sealing portion that is disposed on the organic light-emitting element and seals the organic light-emitting element, and a drying agent film that is formed in a region surrounded by the first and second sealing portions and is mainly composed of a drying agent.

Thus, in the formation of the sealing portions of the organic light-emitting element, the first and second substrates and the first sealing portion surround the organic light-emitting element, the second sealing portion is disposed on the organic light-emitting element, and the drying agent film is disposed in a closed region surrounded by the first and second sealing portions. This structure can prevent water from entering the organic light-emitting element and adsorb water entering the organic light-emitting element, thus enhancing moisture resistance. In particular, the second sealing portion can prevent water from entering the organic light-emitting element from above. The organic EL apparatus therefore has high sealing reliability.

[Aspect 2] In the organic EL apparatus described above, the second sealing portion disposed on the organic light-emitting element is in contact with the second substrate.

This structure restricts the water intrusion path only to the sides of the second sealing portion and increases adhesive strength.

[Aspect 3] In the organic EL apparatus described above, the second sealing portion disposed on the organic light-emitting element completely covers the organic light-emitting element, as viewed from the top.

This structure prevents water intrusion from the outer edge of the organic light-emitting element.

[Aspect 4] In the organic EL apparatus described above, the first sealing portion is separated from the second sealing portion, and the drying agent film surrounds the organic light-emitting element, as viewed from the top.

The drying agent film interrupts the water intrusion path between the first and second sealing portions.

[Aspect 5] In the organic EL apparatus described above, the second substrate has a recessed portion in a region in which the drying agent film is to be formed in the closed space, and the drying agent film is formed in the recessed portion.

This structure restricts an area of the second substrate to which the drying agent is to be applied, prevents the drying agent from extending to regions in which the first and second sealing portions are to be formed, and increases the loading weight of the drying agent.

[Aspect 6] In the organic EL apparatus described above, the surface of the second substrate facing the closed space in a region in which the second sealing portion is formed is recessed relative to the surface of the second substrate facing the closed space in a region in which the first sealing portion is formed, and the second sealing portion has a larger thickness than the first sealing portion.

This structure can prevent the second sealing portion on the organic light-emitting element from pressing the organic light-emitting element.

[Aspect 7] In the organic EL apparatus described above, a sealant of the first sealing portion is different from a sealant of the second sealing portion.

This structure allows the first and second sealing portions to have different functions. For example, the first sealing portion contains filler in consideration of adhesion, and the second sealing portion is formed only of resin.

[Aspect 8] In the organic EL apparatus described above, a sealant of the first sealing portion contains a gap-forming material.

This structure allows gap control only using the first sealing portion, thus preventing the organic light-emitting element from being pressed.

[Aspect 9] In the organic EL apparatus described above, the drying agent film is in contact with the first and second substrates.

This structure can increase the loading weight of the drying agent.

### BRIEF DESCRIPTION OF THE DRAWINGS

The invention will be described with reference to the accompanying drawings, wherein like numbers reference like elements.

FIG. 1 is a circuit diagram of a matrix of pixel regions that constitute an organic EL light-emitting apparatus according to a first embodiment.

FIG. 2 is a plan view of a pixel of the organic EL light-emitting apparatus according to the first embodiment.

FIG. 3A is a plan view of the organic EL light-emitting apparatus according to the first embodiment.

FIG. 3B is a cross-sectional view of the organic EL light-emitting apparatus taken along the line IIIB-IIIB in FIG. 3A.

FIG. 4 is a flow chart illustrating a method for manufacturing the organic EL light-emitting apparatus according to the first embodiment.

FIG. 5A is a plan view of an organic EL light-emitting apparatus according to a second embodiment. FIG. 5B is a cross-sectional view of the organic EL light-emitting apparatus taken along the line VB-VB in FIG. 5A.

FIG. 6A is a plan view of an organic EL light-emitting apparatus according to a third embodiment. FIG. 6B is a cross-sectional view of the organic EL light-emitting apparatus taken along the line VIB-VIB in FIG. 6A.

FIG. 7 is a plan view of an organic EL light-emitting apparatus having a structure suitable for use in an optical write head according to an embodiment of the present invention.

FIG. 8 is a schematic view of an example in which an organic EL light-emitting apparatus according to an embodiment of the present invention is used in an optical write head (printer head) of an electrophotographic printer.

### DESCRIPTION OF EXEMPLARY EMBODIMENTS

Organic electroluminescent light-emitting apparatuses (organic EL light-emitting apparatuses) are described below as embodiments of an organic EL apparatus according to the present invention with reference to the drawings. For the sake of convenient reference, the layers and the components in the drawings referred to in each embodiment are independently appropriately magnified.

### First Embodiment

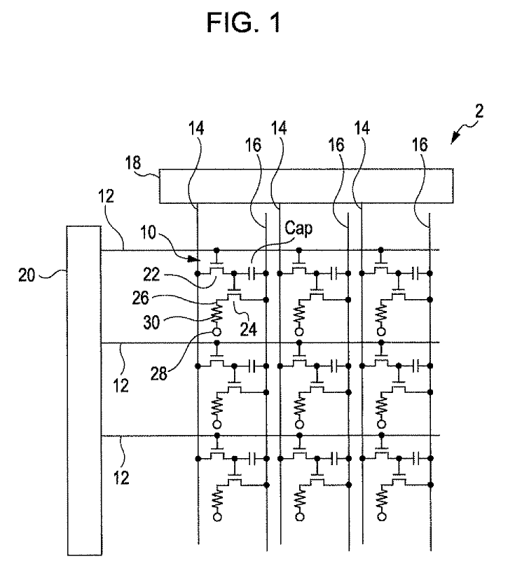

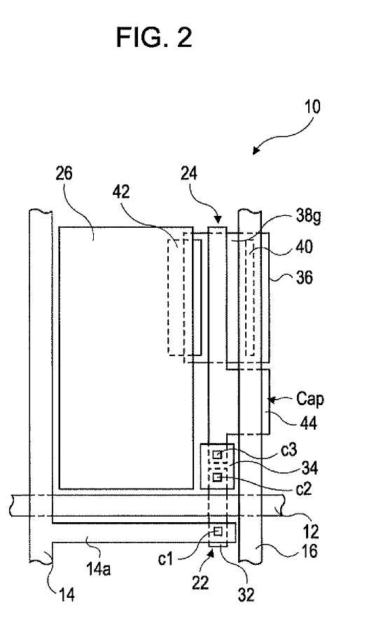

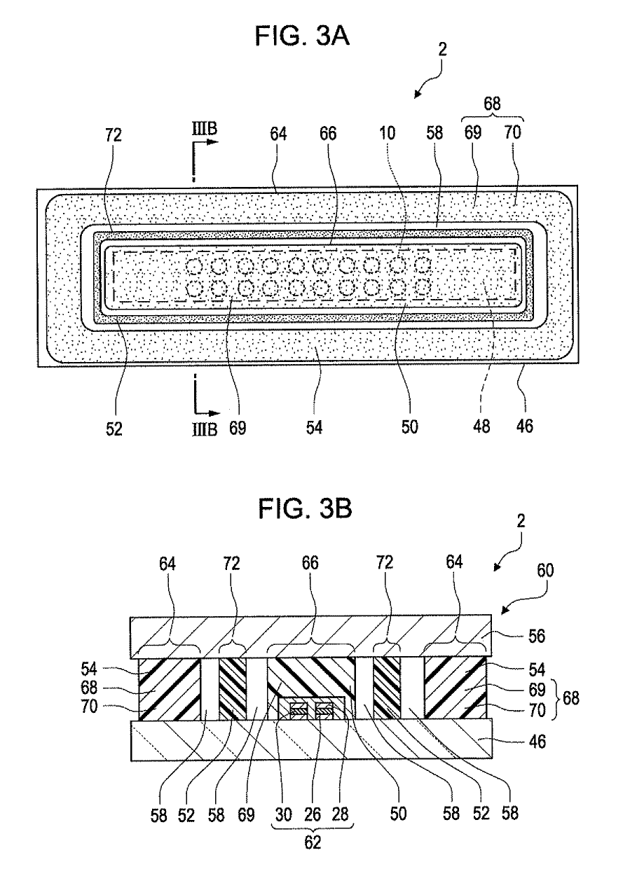

FIG. 1 is a circuit diagram of a matrix of pixel regions that constitute an organic EL light-emitting apparatus 2 according to a first embodiment. FIG. 2 is a plan view of a pixel 10 of the organic EL light-emitting apparatus 2. FIG. 3A is a plan view of the organic EL light-emitting apparatus 2. FIG. 3B is a cross-sectional view of the organic EL light-emitting apparatus 2 taken along the line IIIB-IIIB in FIG. 3A. In FIG. 3A, for the sake of clarity, a second substrate is eliminated.

As illustrated in FIG. 1, the organic EL light-emitting apparatus 2 includes a plurality of scanning lines 12, a plurality of signal lines 14, which intersect the scanning lines 12, a plurality of common feeders 16 parallel to the signal lines 14, and pixels 10 at the points of intersection of the scanning lines 12 and the signal lines 14.

The signal lines 14 are connected to a data drive circuit 18, which includes a shift register, a level shifter, a video line, and an analog switch. The scanning lines 12 are connected to a scanning drive circuit 20, which includes a shift register and a level shifter. Each of the pixels 10 includes a switching thin-film transistor (TFT) 22 in which scanning signals are sent to a gate electrode through a scanning line 12, a capacitance Cap for storing picture signals sent from a signal line 14 through the switching TFT 22, a driving TFT 24 in which picture signals stored in the capacitance Cap are sent to a gate electrode, a pixel electrode 26 to which a driving current flows from a common feeder 16 when the pixel electrode 26 is electrically connected to the common feeder 16 through the driving TFT 24, and an organic light-emitting layer 30 disposed between the pixel electrode 26 and the common electrode 28. The pixel electrode 26, the common electrode 28, and the organic light-emitting layer 30 constitute an organic EL element (organic light-emitting element).

When a scanning line 12 is driven to turn on a switching TFT 22, the electric potential of a signal line 14 at that time point is stored in a capacitance Cap. The on-off state of a driving TFT 24 depends on the status of the capacitance Cap. An electric current flows from a common feeder 16 to a pixel electrode 26 through a channel of the driving TFT 24 and to a common electrode 28 through an organic light-emitting layer 30. The organic light-emitting layer 30 emits light in a manner that depends on the electric current.

Referring to the planar structure of a pixel 10 in FIG. 2, the four sides of a pixel electrode 26 having a substantially rectangular shape as viewed from the top is surrounded by a signal line 14, a common feeder 16, a scanning line 12, and another scanning line of another pixel electrode (not shown). The pixel electrode 26 is adjacent to a switching TFT 22 and a driving TFT 24.

The switching TFT 22 is a top-gate thin-film transistor mainly composed of a rectangular semiconductor layer 32. The scanning line 12 intersecting the semiconductor layer 32 acts as a gate electrode of the switching TFT 22 at the intersection. The semiconductor layer 32 is electrically connected to a branch line 14a through a contact hole c1. The branch line 14a extends along the scanning line 12 from the signal line 14, which extends vertically in the drawing. The semiconductor layer 32 is electrically connected to an interconnection electrode 34 through a contact hole c2. The interconnection electrode 34 has a substantially rectangular shape as viewed from the top and is disposed at the right of the pixel electrode 26 in the drawing.

The driving TFT 24 is a top-gate thin-film transistor mainly composed of a rectangular semiconductor layer 36 and includes a gate electrode 38g, a source electrode 40 (part of the common feeder 16), and a drain electrode 42. The drain electrode 42 is electrically connected to the pixel electrode 26 through a contact hole (not shown). The gate electrode 38g extends downward in the drawing from a position overlapping with the semiconductor layer 36 and is integrated with an electrode 44 of the capacitance Cap. The electrode 44 extends downward and is electrically connected to the overlapping interconnection electrode 34 through a contact hole c3. Thus, a gate of the driving TFT 24 is electrically connected to a drain of the switching TFT 22 through the interconnection electrode 34.

As illustrated in the plan view of FIG. 3A, the organic EL light-emitting apparatus 2 includes a display area 48 substantially in the center of a rectangular element substrate 46 (first substrate). The display area 48 includes a matrix of pixels 10 as viewed from the top. The display area 48 is surrounded by a second sealing portion 50. The display area 48 and the second sealing portion 50 are surrounded by a drying agent film 52 having a rectangular frame shape as viewed from the top. The drying agent film 52 is surrounded by a first sealing portion 54 having a rectangular frame shape. A counter substrate 56 (second substrate) (FIG. 3B) is disposed above the display area 48, the first and second sealing portions 54 and 50, and the drying agent film 52.

Thus, in the organic EL light-emitting apparatus 2, the display area 48, which includes an array of pixels 10 having an organic EL element, is doubly surrounded by the first and second sealing portions 54 and 50, and the drying agent film 52 is disposed between the first and second sealing portions 54 and 50. A closed space 58 between the first sealing portion 54 and the drying agent film 52 uniformly distributes water entering the closed space 58 through the first sealing portion 54 around the drying agent film 52. The closed space 58 can therefore prevent local degradation of the drying agent film 52, improving reliability. Another closed space 58 between the drying agent film 52 and the second sealing portion 50 also uniformly distributes water entering the closed space 58 through the drying agent film 52 around the second sealing portion 50. The closed space 58 can therefore prevent local degradation of the second sealing portion 50, further improving reliability.

As illustrated in the cross-sectional view of FIG. 3B, the organic EL light-emitting apparatus 2 includes a casing 60, an organic EL element 62 in the casing 60, the second sealing portion 50, and the drying agent film 52.

The casing 60 is composed of the element substrate 46, the counter substrate 56 facing the element substrate 46, and the first sealing portion 54, which seals a space between the element substrate 46 and the counter substrate 56 to form the closed space 58. The organic EL element 62, the second sealing portion 50, and the drying agent film 52 are disposed on the top surface of the element substrate 46 and the undersurface of the counter substrate 56 in the closed space 58.

The element substrate 46 not only supports the organic EL element 62, but also functions as a sealing component to hermetically seal the organic EL element 62 and the drying agent film 52. The organic EL light-emitting apparatus 2 according to the present embodiment emits light through the element substrate 46 (anode 26 described below) (bottom emission type). Thus, the element substrate 46 is substantially transparent (colorless and transparent, colored transparent, or translucent).

The element substrate 46 is suitably a translucent glass substrate or a resin substrate. Specific examples of such a substrate include substrates mainly formed of glass materials, such as quartz glass and soda-lime glass, and resin materials, such as poly(ethylene terephthalate), poly(ethylene naphthalate), polypropylene, cycloolefin polymers, polyamide, polyethersulfone, poly(methyl methacrylate), polycarbonate, and polyarylate.

The counter substrate 56 not only supports the drying agent film 52, but also functions as a sealing component to hermetically seal the organic EL element 62 and the drying agent film 52. Since the organic EL light-emitting apparatus 2 according to the present embodiment is of a bottom emission type, the counter substrate 56 is not necessarily translucent. Thus, the counter substrate 56 may be mainly composed of an opaque material, as well as the aforementioned translucent material.

Specific examples of a substrate mainly composed of an opaque material include metal substrates, resin substrates, and ceramic substrates, such as an alumina substrate. These substrates may be coated with a thin film having low water vapor permeability to form multilayer substrates. Examples of a thin film having low water vapor permeability include SiOₓ films, SiNₓ films, SiON films, and metal films. Among others, since metal substrates and multilayer substrates coated with a thin film having low water vapor permeability have low water vapor permeability, particularly excellent moisture barrier properties, they are suitably used as the counter substrate 56.

The first sealing portion 54 seals a space between the element substrate 46 and the counter substrate 56 at their edges (region 64 in which a first sealing portion is to be formed) to form the closed space 58. The first sealing portion 54 functions as a sealing component that hermetically seals the organic EL element 62, the second sealing portion 50, and the drying agent film 52 in the closed space 58.

The second sealing portion 50 seals the top of the organic EL element 62 (region 66 in which a second sealing portion is to be formed) in the closed space 58, functioning as a sealing component that hermetically seals the organic EL element 62. In the present embodiment, the second sealing portion 50 is in contact with the counter substrate 56. This structure can restrict the water intrusion path only to the sides of the second sealing portion 50 and increase the adhesive strength of the element substrate 46 and the counter substrate 56.

The second sealing portion 50 completely covers the organic EL element 62 (cathode 28 described below), as viewed from the top. This structure can prevent water intrusion from the outer edge of the organic light-emitting element 62.

A sealant 68 applied to the region 64 in which a first sealing portion is to be formed is separated from a sealant 69 applied to the region 66 in which a second sealing portion is to be formed. In other words, the first sealing portion 54 is separated from the second sealing portion 50. Thus, the drying agent film 52 disposed between the first and second sealing portions 54 and 50 can interrupt the water intrusion path. The sealant 68 of the first sealing portion 54 may be different from the sealant 69 of the second sealing portion 50. Thus, the first sealing portion 54 and the second sealing portion 50 can have different functions. For example, the first sealing portion 54 contains filler in consideration of adhesion, and the second sealing portion 50 is formed only of resin. In the present embodiment, the sealant 68 of the first sealing portion 54 contains the sealant 69 and a gap-forming material 70. This allows gap control only using the first sealing portion 54, thus preventing the organic light-emitting element 62 from being pressed.

The sealant 69 has a function of coupling the element substrate 46 with the counter substrate 56. Examples of the component of the sealant 69 include metallic materials, such as Al, Au, Cr, Nb, Ta, and Ti, alloys containing these metallic materials, inorganic oxides, such as silicon oxide, and resin materials, such as epoxy resin, acrylic resin, polyester resin, and polyamide resin. Among others, resin materials are preferred. For example, the sealant 69 may be composed of a thermosetting resin material. Alternatively, the sealant 69 may be composed of a photocurable epoxy resin that is cured by ultraviolet light (UV) irradiation. In a process for forming a sealing portion described below, the first sealing portion 54 can be formed by a relatively simple process in which a resin material that contains the gap-forming material 70 is cured between the element substrate 46 and the counter substrate 56 (heat curing or UV curing).

The gap-forming material 70 has a function of defining the thickness of the first sealing portion 54, that is, the distance between the element substrate 46 and the counter substrate 56. More specifically, a resin material that contains the gap-forming material 70 can be supplied between the element substrate 46 and the counter substrate 56 to form the first sealing portion 54, thereby forming the closed space 58 having a predetermined size between the element substrate 46 and the counter substrate 56,

The gap-forming material 70 may be particles of any shape and is preferably spherical, ellipsoidal, or polygonal and more preferably spherical. Use of particulate gap-forming material 70 allows the distance between the element substrate 46 and the counter substrate 56 to be kept constant in a process for forming a sealing portion described below. Thus, the first sealing portion 54 can have a uniform thickness, and the distance between the second sealing portion 50 including the organic EL element 62 and the drying agent film 52 can be kept uniform.

Examples of the component of the gap-forming material 70 include metallic materials, such as Al, Au, Cr, Nb, Ta, and Ti, alloys containing these metallic materials, and inorganic oxides, such as silicon oxide. These components may be used alone or in combination. The gap-forming material 70 may be mainly composed of the above-mentioned component or may be partly or substantially entirely composed of a drying agent. When the gap-forming material 70 contains a drying agent, even if the organic EL light-emitting apparatus 2 (closed space 58) contains residual water, the drying agent in the first sealing portion 54, together with a drying agent in the drying agent film 52 described below, can adsorb the water. The water adsorption (trap) in the first sealing portion 54 can more securely prevent water intrusion from the organic EL light-emitting apparatus 2 to the closed space 58 through the first sealing portion 54. When the second sealing portion 50 contains a drying agent, even if the organic EL light-emitting apparatus 2 (closed space 58) contains residual water, the drying agent in the second sealing portion 50, together with the drying agent in the drying agent film 52 described below, can adsorb the water. The water adsorption (trap) in the second sealing portion 50 can more securely prevent water intrusion from the closed space 58 to the organic EL element 62 through the second sealing portion 50.

The drying agents in the first and second sealing portions 54 and 50 may be the same as the drying agent in the drying agent film 52 described below. The first and second sealing portions 54 and 50 preferably have a water vapor permeability (according to JIS K 7129) of 10 or less, more preferably about one to five [g/(m²·day) at 90% RH], at an ambient temperature of 40° C. Under these conditions, the first sealing portion 54 functions appropriately as a barrier layer to prevent water intrusion from the outside of the organic EL light-emitting apparatus 2 to the closed space 58. The second sealing portion 50 also functions appropriately as a barrier layer to prevent water intrusion from the closed space 58 to the organic EL element 62.

The water permeability can be determined by a humidity sensor method according to JIS K 7129 at a test (ambient) temperature of 40° C±0.5° C. and a relative humidity difference of 90%±2% RH. In the humidity sensor method, one side of the counter substrate 56 (test specimen) is saturated with water vapor, and the humidity at the other (low humidity) side is set at 10% RH. A change in humidity due to water vapor passing through the test specimen is detected with a humidity sensor installed on the low humidity side and is converted into an electric signal. The water vapor transmission time is measured at a constant relative humidity width (90% RH) to examine the steady state of the water vapor transmission rate. The water vapor permeability is calculated from the water vapor transmission time.

When at least one of the element substrate 46 and the counter substrate 56 is flexible, instead of the formation of the first sealing portion 54, the flexible substrate may be deformed to bring the element substrate 46 and the counter substrate 56 into contact with each other. The contact portion is sealed to impart the function of the first sealing portion 54 to the element substrate 46 and/or the counter substrate 56. When the organic EL light-emitting apparatus 2 is used as a flexible display, the casing 60, that is, all the above-mentioned element substrate 46, counter substrate 56, and first and second sealing portions 54 and 50 may be mainly composed of resin materials.

The drying agent film 52 is disposed in a region 72 in which a drying agent film is to be formed, which is surrounded by the first and second sealing portions 54 and 50 under the counter substrate 56 in the closed space 58. In the present embodiment, the drying agent film 52 is in contact with both the element substrate 46 and the counter substrate 56. The region 72 in which a drying agent film is to be formed may be disposed on one or both of the element substrate 46 and the counter substrate 56. Such a structure can increase the loading weight of the drying agent in the drying agent film 52.

The drying agent film 52 surrounds the organic light-emitting element 62, as viewed from the top. The drying agent film 52 is formed of a coat-type drying agent in a toroidal region between the first and second sealing portions 54 and 50, as viewed from the top. Thus, the drying agent film 52 between the first and second sealing portions 54 and 50 interrupts the water intrusion path. The drying agent film 52 is mainly composed of a drying agent and has a function of adsorbing water remaining in or entering the closed space 58. Thus, even if water remains in or enters the organic EL light-emitting apparatus 2 (closed space 58), the drying agent in the drying agent film 52 can properly adsorb the water. Hence, the drying agent film 52 can prevent water from entering the organic EL element 62 for a long period of time, thereby preventing deterioration in performance of the organic EL element 62.

In the present embodiment, as illustrated in FIG. 3A, the drying agent film 52 is formed to fit the shape of the organic EL element 62 described below. Such a structure allows the whole organic EL element 62 to be dried, thus preventing local water intrusion in the organic EL element 62. The drying agent film 52 is formed by supplying a liquid material that contains a drying agent to the region 72 in which a drying agent film is to be formed and drying the liquid material. A specific example of the liquid material that contains a drying agent and a method for forming the drying agent film 52 will be described in detail below with a process for forming a drying agent film.

The organic EL element 62 is disposed in a region corresponding to the closed space 58 on the element substrate 46. As illustrated in FIG. 3B, the organic EL element 62 includes an anode 26, a cathode 28, and an organic light-emitting layer 30 between the anode 26 and the cathode 28. The organic light-emitting layer 30 may be any layer that includes an organic light-emitting layer, for example, I: a layered structure that includes a hole-transporting layer, an organic light-emitting layer, and an electron-transporting layer on the anode 26 in this order, II: a layered structure in which the hole-transporting layer or the electron-transporting layer is removed from the structure I, or III: a monolayer structure in which the hole-transporting layer and the electron-transporting layer are removed from the structure I. The structure I is described below as a typical example.

The anode 26 injects positive holes into the organic light-emitting layer 30 (hole-transporting layer in the present embodiment). Since the organic EL light-emitting apparatus 2 is of a bottom emission type that emits light through the anode 26, the component of the anode 26 (anode material) is a translucent electroconductive material and, in particular, suitably has a large work function and high electrical conductivity.

Examples of the component of the anode 26 include transparent electroconductive materials, such as indium tin oxide (ITO), fluorine-containing indium tin oxide (FITO), antimony tin oxide (ATO), indium zinc oxide (IZO), aluminum zinc oxide (AZO), tin oxide (SnO₂), zinc oxide (ZnO), fluorine-containing tin oxide (FTO), fluorine-containing indium oxide (FIO), and indium oxide (IO). These materials are used alone or in combination. The anode 26 preferably has a transmittance of light (visible light region) of at least 60%, more preferably at least 80%, to emit light efficiently from the anode 26.

The cathode 28 injects electrons into the organic light-emitting layer 30 (electron-transporting layer in the present embodiment). The component of the cathode 28 (cathode material) has high electrical conductivity and, in particular, suitably has a small work function to improve the injection efficiency of electrons into the electron-transporting layer.

Examples of the component of the cathode 28 include alkali metals of Li, Na, K, Rb, Cs, and Fr and alkaline earth metals of Be, Mg, Ca, Sr, Ba, and Ra. These components may be used alone or in combination. When the component of the cathode 28 is an alloy that contains the above-mentioned metal, the alloy may contain a stable metal, such as Ag, Al, or Cu, and, more specifically, may be a MgAg, AlLi, or CuLi alloy. Use of the cathode 28 composed of such an alloy can improve the injection efficiency of electrons into the electron-transporting layer and the stability of the cathode 28.

As described above, the organic light-emitting layer 30 that includes the hole-transporting layer, the organic light-emitting layer, and the electron-transporting layer on the anode 26 in this order is disposed between the anode 26 and the cathode 28. The hole-transporting layer has a function of transporting positive holes, which were injected from the anode 26, to the organic light-emitting layer. Examples of the component of the hole-transporting layer (hole-transporting material) include polyethylenedioxythiophene/poly(styrene sulfonate), polyaniline/poly(styrene sulfonate), polyarylamine, fluorene-arylamine copolymers, fluorene-bithiophene copolymers, poly(N-vinylcarbazole), polyvinylpyrene, polyvinylanthracene, polythiophene, polyalkylthiophene, polyhexylthiophene, poly(p-phenylenevinylene), poly(ethynylen vinylene), pyrene-formaldehyde resin, ethylcarbazole-formaldehyde resin, and derivatives thereof. These components may be used alone or in combination.

A hole-injection layer (PEDOT) may be disposed between the anode 26 and the hole-transporting layer to improve the hole-injection efficiency from the anode 26. Examples of the component of the hole-injection layer (hole-injection material) include copper phthalocyanine and 4,4′,4″-tris(N,N-phenyl-3-methylphenylamino)triphenylamine (m-MTDATA).

The electron-transporting layer has a function of transporting electrons, which were injected from the cathode 28, to the organic light-emitting layer. Examples of the component of the electron-transporting layer (electron-transporting material) include benzene compounds, such as 1,3,5-tris[(3-phenyl-6-tri-fluoromethyl)quinoxaline-2-yl]benzene (TPQ1), naphthalene compounds, phenanthrene compounds, chrysene compounds, perylene compounds, anthracene compounds, pyrene compounds, acridine compounds, stilbene compounds, thiophene compounds, such as BBOT, butadiene compounds, coumarin compounds, quinoline compounds, bistyryl compounds, pyrazine compounds, such as distyrylpyrazine, quinoxaline compounds, benzoquinone compounds, such as 2,5-diphenyl-p-benzoquinone, naphthoquinone compounds, anthraquinone compounds, oxadiazole compounds, such as 2-(4-biphenylyl)-5-(4-t-butylphenyl)-1,3,4-oxadiazole (PBD), triazole compounds, such as 3,4,5-triphenyl-1,2,4-triazole, oxazole compounds, anthrone compounds, fluorenone compounds, such as 1,3,8-trinitro-fluorenone (TNF), diphenoquinone compounds, such as MBDQ, stilbenequinone, such as MBSQ, anthraquinodimethane compounds, thiopyran dioxide compounds, fluorenylidenemethane, diphenyldicyanoethylene compounds, fluorene compounds, pyrrole compounds, phosphine oxide compounds, 8-hydroxyquinoline aluminum (Alq₃), and various metal complexes that contain benzoxazole and benzothiazole as ligands. These components may be used alone or in combination.

An electron-injection layer (such as alkaline earth metal) may be disposed between the cathode 28 and the electron-transporting layer to improve the injection efficiency of electrons from the cathode 28 to the electron-transporting layer. Examples of the component of the electron-injection layer (electron-injection material) include 8-hydroxyquinoline, oxadiazole, and derivatives thereof (for example, metal chelated oxinoid compounds that contains 8-hydroxyquinoline). These components may be used alone or in combination.

Upon the passage of an electric current (the application of a voltage) between the anode 26 and the cathode 28, positive holes moving through the hole-transporting layer are injected into the organic light-emitting layer 30, and electrons moving through the electron-transporting layer are injected into the organic light-emitting layer 30. Thus, the positive holes recombine with the electrons, forming excitons, in the organic light-emitting layer 30. The excitons release energy (produce fluorescence or phosphorescence) while being cooled to the ground state.

Examples of the component of the organic light-emitting layer 30 (organic light-emitting material) include benzene compounds, such as 1,3,5-tris[(3-phenyl-6-tri-fluoromethyl)quinoxaline-2-yl]benzene (TPQ1) and 1,3,5-tris[{3-(4-t-butylphenyl)-6-trisfluoromethyl}quinoxaline-2-yl]benzene (TPQ2), metal or metal-free phthalocyanine compounds, such as phthalocyanine, copper phthalocyanine (CuPc), and iron phthalocyanine, low-molecular-weight compounds, such as tris(8-hydroxyquinolinolate)aluminum (Alq₃) and fac-tris(2-phenylpyridine)iridium (Ir(ppy)₃), and polymers, such as oxadiazole polymers, triazole polymers, carbazole polymers, and fluorene polymers. These components may be used alone or in combination. Various polymeric materials and various low-molecular-weight materials may be used alone or in combination.

The organic EL light-emitting apparatus 2 includes the drying agent film 52 on the undersurface of the counter substrate 56. Thus, even if water remains in or enters the organic EL light-emitting apparatus 2 (closed space 58), the drying agent can adsorb the water and prevent the water from entering the organic EL element 62 for a long period of time, thereby suitably reducing or preventing deterioration in performance of the organic EL element 62.

A plurality of drying agent films 52 may be individually provided on the undersurface of the counter substrate 56 for each organic EL element 62. Alternatively, a single drying agent film 52 may be disposed around the organic EL elements 62.

A method for manufacturing the organic EL light-emitting apparatus 2 according to the present embodiment will be described below.

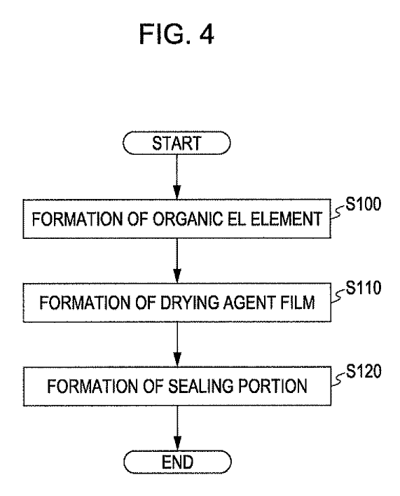

FIG. 4 is a flow chart illustrating a method for manufacturing the organic EL light-emitting apparatus 2 according to the present embodiment. The method for manufacturing the organic EL light-emitting apparatus 2 includes a process for forming an organic EL element, a process for forming a drying agent film, and a process for forming a sealing portion. These processes will be described below.

### Process for Forming Organic EL Element (Process S100)

An organic EL element 62 is formed on an element substrate 46 in the following manner. First, an anode 26 is formed on the element substrate 46, for example, by chemical vapor deposition (CVD), such as plasma CVD, thermal CVD, or laser CVD, vacuum evaporation, sputtering, dry plating, such as ion plating, wet plating, such as electroplating, immersion plating, or electroless plating, thermal spraying, a sol-gel process, a metal organic decomposition (MOD) method, or bonding of metallic foil.

A hole-transporting layer is then formed on the anode 26.

The hole-transporting layer can be formed, for example, by applying a liquid material for the formation of the hole-transporting layer in which the aforementioned hole-transporting material is dissolved in a solvent or dispersed in a dispersion medium to the anode 26 and drying the liquid material (removal of solvent or dispersion medium). The liquid material for the formation of the hole-transporting layer may be applied to the anode 26 by spin coating, casting, microgravure coating, gravure coating, bar coating, roll coating, wire bar coating, dip coating, spray coating, screen printing, flexography, offset printing, or ink jet printing. The hole-transporting layer can be formed relatively easily by such a coating method.

Examples of the solvent or dispersion medium for use in the preparation of the liquid material for the formation of the hole-transporting layer include inorganic solvents, such as ammonia, hydrogen peroxide, and water; organic solvents, for example, ketone solvents, such as methyl ethyl ketone (MEK) and acetone, alcohol solvents, such as methanol, ethanol, and isopropanol, ether solvents, such as diethyl ether and diisopropyl ether, cellosolve solvents, such as methyl cellosolve and ethyl cellosolve, aliphatic hydrocarbon solvents, such as hexane and pentane, aromatic hydrocarbon solvents, such as toluene, xylene, and benzene, and heteroaromatic solvents, such as pyridine and pyrazine; and mixed solvents thereof. The drying may be performed by leaving the liquid material alone at atmospheric or reduced pressure, by heat treatment, or by spraying an inert gas.

An organic light-emitting layer is then formed on the hole-transporting layer (the opposite side of the anode 26).

The organic light-emitting layer can be formed, for example, by applying a liquid material for the formation of the organic light-emitting layer in which the aforementioned organic light-emitting material is dissolved in a solvent or dispersed in a dispersion medium to the hole-transporting layer and drying the liquid material (removal of solvent or dispersion medium). The liquid material for the formation of the organic light-emitting layer are applied and dried in the same manner as described in the formation of the hole-transporting layer.

When the aforementioned organic light-emitting material is used, the solvent or dispersion medium for use in the preparation of the liquid material for the formation of the organic light-emitting layer is suitably a nonpolar solvent. Examples of the nonpolar solvent include aromatic hydrocarbon solvents, such as xylene, toluene, cyclohexylbenzene, dihydrobenzofuran, trimethylbenzene, and tetramethylbenzene, heteroaromatic solvents, such as pyridine, pyrazine, furan, pyrrole, thiophene, and methylpyrrolidone, and aliphatic hydrocarbon solvents, such as hexane, pentane, heptane, and cyclohexane. These solvents may be used alone or in combination.

An electron-transporting layer is then formed on the organic light-emitting layer (the opposite side of the hole-transporting layer).

The electron-transporting layer can be formed, for example, by applying a liquid material for the formation of the electron-transporting layer in which the aforementioned electron-transporting material is dissolved in a solvent or dispersed in a dispersion medium to the organic light-emitting layer and drying the liquid material (removal of solvent or dispersion medium). The solvent or dispersion medium for use in the preparation of the liquid material for the formation of the electron-transporting layer, and application and drying of the liquid material for the formation of the electron-transporting layer are the same as described in the formation of the hole-transporting layer.

The cathode 28 is then formed on the electron-transporting layer (the opposite side of the organic light-emitting layer).

The cathode 28 can be formed, for example, by vacuum evaporation, sputtering, bonding of metallic foil, or application of fine metal particle ink and firing. Through these steps, the organic EL element 62 is formed on the element substrate 46.

### Process for Forming Drying Agent Film (Process S110)

As illustrated in FIG. 3B, the drying agent film 52 is then formed on the counter substrate 56 in a region 72 in which a drying agent film is to be formed. In a method for manufacturing an organic light-emitting apparatus according to the present embodiment, the drying agent film 52 is formed by applying a liquid material that contains a drying agent to the counter substrate 56 in a region 72 in which a drying agent film is to be formed, which is surrounded by a region in which a liquid-repellent film is to be formed, and drying (curing) the liquid material (removal of solvent or dispersion medium) (UV irradiation).

When a liquid material that contains a drying agent mainly composed of a sticky or adhesive compound is applied to the region 72 in which a drying agent film is to be formed, and is dried, the drying agent adheres to the region 72, forming the drying agent film 52. When a liquid material that contains a resin material and a drying agent mainly composed of a nonsticky and nonadhesive compound is applied to the region 72 in which a drying agent film is to be formed, and is dried, the drying agent film 52 in which the drying agent is supported by the resin material is formed in the region 72. The resin material in the liquid material may be the same as described for the next process (a process for forming a sealing portion).

Thus, whether the drying agent is mainly composed of a sticky or adhesive compound or a nonsticky and nonadhesive compound, the drying agent film 52 can be formed on the counter substrate 56 in the region 72 in which a drying agent film is to be formed. However, preferably, the drying agent film is mainly composed of a sticky or adhesive compound. In the absence of materials other than the drying agent in the drying agent film 52, the drying agent film 52 can have high hygroscopicity. In addition, the sticky or adhesive drying agent rarely peels off the counter substrate 56.

The drying agent may be of any type and may be composed of one or at least two compounds selected from the group consisting of oxides, halides, sulfates, perchlorates, carbonates, and organic substances. More specifically, the drying agent is preferably phosphorus pentoxide (P₄O₁₀), barium oxide (BaO), magnesium oxide (MgO), calcium oxide (CaO), or alumina (Al₂O₃). Among others, phosphorus pentoxide is preferred because it has a water absorption capacity 35 times larger than barium oxide and imparts long-term moisture resistance to the organic EL light-emitting apparatus 2 at a small loading weight. Preferably, a particulate drying agent is uniformly dispersed in a drying agent-containing layer, because this improves hygroscopicity and, even when a deliquescent drying agent is used, efficiently prevents the drying agent from leaking out. In this case, the drying agent preferably has an average particle size of 20 μm or less and more preferably ranges from 0.1 to 10 μm.

The resin material may also be of any type and may be one or at least two resins selected from the group consisting of vinyl chloride resins, phenolic resins, silicone resins, epoxy resins, polyester resins, urethane resins, acrylic resins, and olefin resins. More preferably, the resin material has a function of adhesion; that is, the resin material is an adhesive. Thus, the drying agent-containing layer can be easily formed on the undersurface of the counter substrate by using an adhesive.

Preferably, the above-mentioned resin contains a photocurable resin. The drying agent-containing layer can be formed on the undersurface of the counter substrate in a very short period of time by curing the photocurable resin. This can reduce the production time. The photocurable resin may be one or at least two resins selected from the group consisting of silicone resins, epoxy resins, acrylic resins, polybutadiene resins, and vinyl acetate resins. In particular, polybutadiene photocurable resins and vinyl acetate photocurable resins are preferred because of their high hygroscopicity (moisture permeability).

The mixing ratio of the drying agent to the resin in the drying agent-containing layer will be described below. The mixing ratio may be determined in consideration of the long-term moisture resistance of an organic EL element. Preferably, the mixing ratio ranges from 1:100 to 100:1 by weight ratio. At a mixing ratio below 1:100, the organic EL element may have low long-term moisture resistance. At a mixing ratio above 100:1, the drying agent-containing layer may be difficult to form.

In consideration of the balance between the long-term moisture resistance of the organic EL element and the formability of the drying agent-containing layer, the mixing ratio of the drying agent to the resin ranges more preferably from 1:10 to 10:1, still more preferably from 1:5 to 5:1, by weight ratio.

The thickness of the drying agent-containing layer will be described below. The thickness of the drying agent-containing layer may be determined in consideration of the long-term moisture resistance of the organic EL element and preferably ranges from 0.1 to 1000 μm. At a thickness of the drying agent-containing layer below 0.1 μm, the organic EL element may have low long-term moisture resistance. At a thickness of the drying agent-containing layer above 1000 μm, the drying agent-containing layer may be difficult to form.

In consideration of the balance between the long-term moisture resistance of the organic EL element and the formability of the drying agent-containing layer, the thickness of the drying agent-containing layer ranges more preferably from 1 to 100 μm and still more preferably from 5 to 50 μm.

Preferably, a drying agent-free layer is entirely or partly disposed on the surface of the drying agent-containing layer. Even when a deliquescent drying agent is used, the drying agent-free layer can effectively prevent a deliquescing drying agent from leaking out the drying agent-containing layer. Furthermore, even when the drying agent physically adsorbs water, the drying agent-free layer can effectively prevent adsorbed water from being released.

Preferably, the drying agent-free layer is formed of the same resin as used in the drying agent-containing layer. More preferably, the drying agent-free layer has a thickness in the range of 0.1 to 1000 μm.

The content of the drying agent in the liquid material ranges preferably from about 100 to 10000 mg/L and more preferably from about 300 to 5000 mg/L. When the content of the drying agent is lower than this range, the drying agent film 52 may have an insufficient thickness, resulting in poor performance of the drying agent in the drying agent film 52. When the content of the drying agent is higher than this range, the liquid material may have poor coating performance, and it may be difficult to form a drying agent film having a uniform thickness.

Examples of the solvent or dispersion medium for use in the preparation of the liquid material that contains the drying agent include aromatic hydrocarbon solvents, such as toluene and xylene, and aliphatic hydrocarbon solvents, such as hexane, pentane, heptane, and cyclohexane. Application of the liquid material to the counter substrate 56 in the region 72 in which a drying agent film is to be formed and drying are performed in the same manner as described for the process for forming a hole-transporting layer in the above-mentioned process (process for forming an organic EL element).

The amount of applied liquid material ranges preferably from about 1.0 to 10.0 μL/cm² and more preferably from about 2.0 to 4.0 μL/cm². Within this range, the drying agent film 52 having an excellent drying effect can be formed on the counter substrate 56. The drying temperature ranges preferably from about 100° C. to 250° C. and more preferably from about 150° C. to 200° C.

The drying time ranges preferably from about 5 to 120 min and more preferably from about 10 to 40 min. In the present embodiment, as illustrated in FIG. 3B, the drying agent film 52 has such a thickness that the undersurface of the drying agent film 52 is in contact with the top surface of the element substrate 46. However, the drying agent film 52 may have such a thickness that the undersurface of the drying agent film 52 is not in contact with the top surface of the element substrate 46.

### Process for Forming Sealing Portion (Process S120)

As illustrated in FIG. 3B, the element substrate 46 and the counter substrate 56 are coupled by forming the first sealing portion 54 that seals a space between the element substrate 46 and the counter substrate 56 at their edges and the second sealing portion 50 that seals the top of the organic EL element 62. In the present embodiment, the second sealing portion 50 has such a thickness that the top surface of the second sealing portion 50 is in contact with the undersurface of the counter substrate 56. Such a structure can reduce the thickness of the organic EL light-emitting apparatus 2 and efficiently dissipate heat generated by the organic EL element 62 in operation into the outside of the organic EL light-emitting apparatus 2 by conduction through the second sealing portion 50 and the counter substrate 56. While the first sealing portion 54 is composed of the aforementioned sealant 69 and the gap-forming material 70, a process for forming the first sealing portion 54 using the sealant 68 formed of a resin material will be described below.

First, a resin material (sealant 68) that contains the gap-forming material 70 is applied to the counter substrate 56 in a region 64 in which a first sealing portion is to be formed. A resin material (sealant 69) that contains no gap-forming material is applied to the counter substrate 56 in a region 66 in which a second sealing portion is to be formed.

The side of the element substrate 46 on which the organic EL element 62 was formed is coupled, through the resin material (sealant 68), with the side of the counter substrate 56 on which the drying agent film 52 was formed. The resin material is dried by heating or cured by UV irradiation. In WV curing, the resin material is irradiated with WV light through the element substrate 46. To prevent the deterioration of the organic EL element due to UV light, a region other than the portion to be bonded, particularly a light-emitting region, may be protected with a mask. The resin material of the first sealing portion 54 contains the gap-forming material 70. The gap-forming material 70 defines the distance between the element substrate 46 and the counter substrate 56. In other words, the size of the gap-forming material 70 is determined such that the first and second sealing portions 54 and 50 have a desired thickness. The process for forming a sealing portion is preferably performed in a dry atmosphere, such as inert gas that contains a minimum amount of water (for example, dry nitrogen) or dry air. A dry atmosphere can minimize water entering the organic EL light-emitting apparatus 2 (closed space 58) and the organic EL element 62. In the present embodiment, as illustrated in FIG. 3B, the second sealing portion 50 has such a thickness that the top surface of the second sealing portion 50 is in contact with the undersurface of the counter substrate 56. However, the second sealing portion 50 may have such a thickness that the top surface of the second sealing portion 50 is not in contact with the undersurface of the counter substrate 56.

In accordance with the present embodiment, in the formation of the sealing portions of the organic light-emitting element 62, the element substrate 46, the counter substrate 56, and the first sealing portion 54 surround the organic light-emitting element 62, the second sealing portion 50 is formed on the organic light-emitting element 62, and the drying agent film 52 is formed in a closed region surrounded by the first and second sealing portions 54 and 50. This structure can prevent water from entering the organic light-emitting element 62 and adsorb water entering the organic light-emitting element 62, thus enhancing moisture resistance. In particular, the second sealing portion 50 can prevent water from entering the organic light-emitting element 62 from above.

### Second Embodiment

A second embodiment will be described below with reference to the drawings.

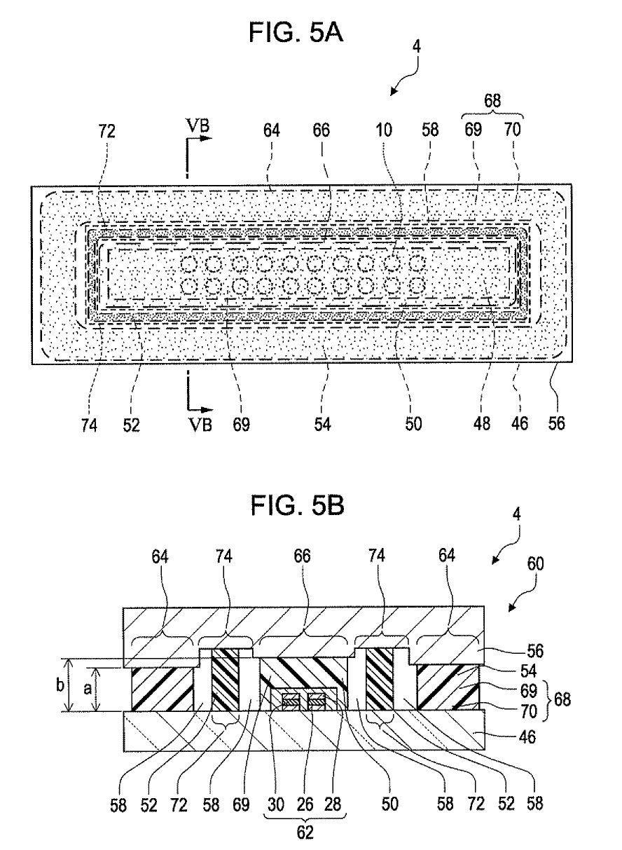

FIG. 5A is a plan view of an organic EL light-emitting apparatus 4 according to the second embodiment. FIG. 5B is a cross-sectional view of the organic EL light-emitting apparatus 4 taken along the line VB-VB in FIG. 5A. The organic EL light-emitting apparatus 4 has the same basic structure as the organic EL light-emitting apparatus 2 according to the first embodiment, except that a counter substrate 56 has a depression (recessed portion) 74, and that the thickness a of a first sealing portion 54 is different from the thickness b of a second sealing portion 50. Thus, the same components used in the present embodiment as in the first embodiment are denoted by the same reference numerals and will not be further described.

As illustrated in FIG. 5, the organic EL light-emitting apparatus 4 according to the present embodiment has the depression 74 in the counter substrate 56 corresponding to a region 72 in which a drying agent film is to be formed. A drying agent film 52 is formed in the depression 74. This structure restricts an area of the counter substrate 56 to which a drying agent is to be applied, prevents the drying agent from extending to regions in which first and second sealing portions 54 and 50 are to be formed, and increases the loading weight of the drying agent. The depression 74 in the counter substrate 56 may be formed by blasting or wet etching.

The surface of the counter substrate 56 facing a closed space 58 in a region 66 in which the second sealing portion 50 is formed is recessed relative to the surface of the counter substrate 56 facing the closed space 58 in a region 64 in which the first sealing portion 54 is formed, and the thickness b of the second sealing portion 50 is larger than the thickness a of the first sealing portion 54. This structure can prevent the second sealing portion 50 disposed on an organic light-emitting element 62 from pressing the organic light-emitting element 62.

### Third Embodiment

A third embodiment will be described below with reference to the drawings.

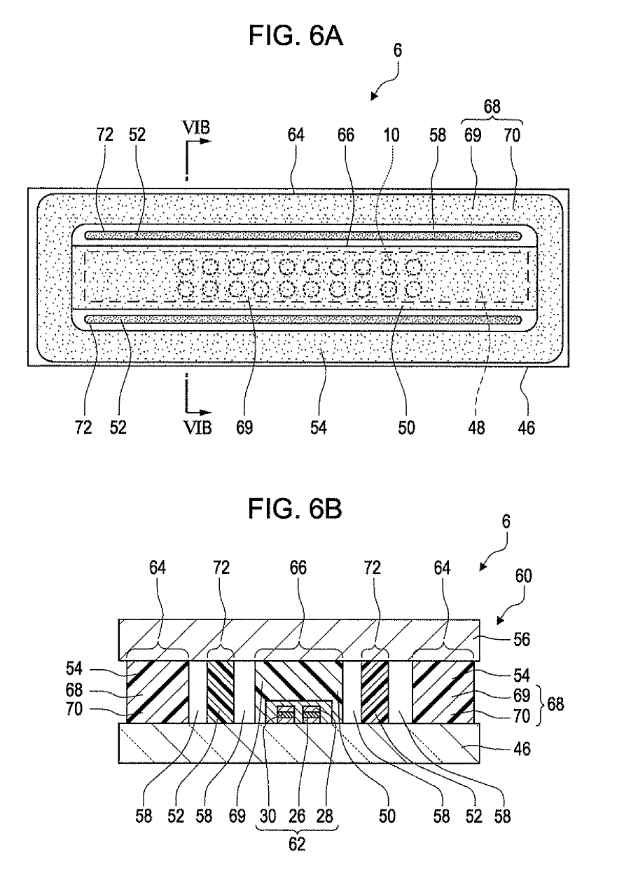

FIG. 6A is a plan view of an organic EL light-emitting apparatus 6 according to the third embodiment. FIG. 6B is a cross-sectional view of the organic EL light-emitting apparatus 6 taken along the line VIB-VIB in FIG. 6A. In FIG. 6A, for the sake of clarity, a counter substrate is eliminated. The organic EL light-emitting apparatus 6 has the same basic structure as the organic EL light-emitting apparatus 2 according to the first embodiment, except that a first sealing portion 54 is in contact with a second sealing portion 50. Thus, the same components used in the present embodiment as in the first embodiment are denoted by the same reference numerals and will not be further described.

In the organic EL light-emitting apparatus 6 according to the present embodiment, as illustrated in FIG. 6, a sealant 68 applied to a region 64 in which a first sealing portion is to be formed is in contact with a sealant 69 applied to a region 66 in which a second sealing portion is to be formed. A coat-type drying agent is applied to two regions surrounded by the first and second sealing portions 54 and 50 to form drying agent films 52.

### Optical Write Head

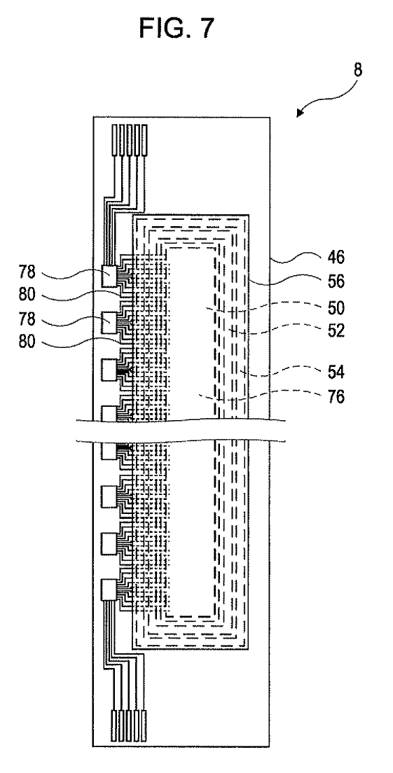

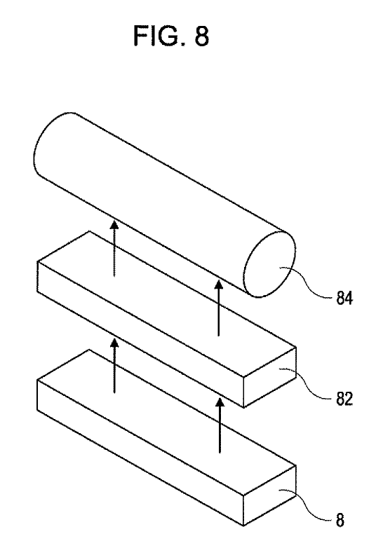

An optical write head including an organic EL light-emitting apparatus according to another embodiment will be described below with reference to FIGS. 7 and 8.

FIG. 7 is a plan view of an organic EL light-emitting apparatus 8 having a structure suitable for use in an optical write head according to an embodiment of the present invention.

As illustrated in FIG. 7, an organic EL light-emitting apparatus 8 includes a light-emitting element region 76, which is longitudinally disposed on an element substrate 46, and a plurality of driver elements 78 disposed along the light-emitting element region 76. In the light-emitting element region 76, organic EL elements (not shown) are arranged on the element substrate 46. While details are omitted in FIG. 7, the organic EL elements in the light-emitting element region 76 are electrically connected to connection lines 80 extending from driver elements 78. The organic EL elements are driven by electric signals from the driver elements 78.

The organic EL light-emitting apparatus 8 according to the present embodiment also has a sealed structure as in the organic EL light-emitting apparatuses 2, 4, and 6 according to the previous embodiments. More specifically, a protective layer (not shown) is formed on the organic EL elements in the light-emitting element region 76. The light-emitting element region 76 is covered with a second sealing portion 50. The second sealing portion 50 is surrounded by a drying agent film 52. The drying agent film 52 is surrounded by a first sealing portion 54. The first sealing portion 54, the second sealing portion 50, and the drying agent film 52 are covered with a counter substrate 56.

As in the organic EL light-emitting apparatuses 2, 4, and 6 according to the previous embodiments, the organic EL light-emitting apparatus 8 having such a structure includes the drying agent film 52 and the first and second sealing portions 54 and 50. The double sealed structure including the first and second sealing portions 54 and 50 can satisfactorily seal the light-emitting element region 76.

FIG. 8 is a schematic view of an example in which the organic EL apparatus 8 described above is used in an optical write head (printer head) of an electrophotographic printer. In FIG. 8, an optical system 82 is disposed in the direction of light emission (upward in the drawing) of the organic EL light-emitting apparatus 8. A photosensitive drum (photoreceptor) 84 is disposed over the optical system 82. The organic EL light-emitting apparatus 8 emits light to the optical system 82. The light is condensed by the optical system 82 and reaches the photosensitive drum 84. In the present embodiment, the light-emitting element region 76 (see FIG. 7) can be satisfactorily sealed, and the whole electrophotographic printer can have improved reliability.

The entire disclosure of Japanese Patent Application No. 2008-109878, filed Apr. 21, 2008 is expressly incorporated by reference herein.

What is claimed is:

1. An organic electroluminescent apparatus comprising:
a first substrate and a second substrate facing each other;
a first sealing portion that seals the first and second substrates so as to form a closed space between the first and second substrates;
an organic light-emitting element that is disposed on the first substrate in the closed space and includes an organic light-emitting layer mainly composed of an organic light-emitting material;
a second sealing portion that is disposed on the organic light-emitting element and seals the organic light-emitting element; and
a drying agent film that is formed in a region surrounded by the first and second sealing portions and is mainly composed of a drying agent.

2. The organic electroluminescent apparatus according to claim 1, wherein the second sealing portion disposed on the organic light-emitting element is in contact with the second substrate.

3. The organic electroluminescent apparatus according to claim 1, wherein the second sealing portion disposed on the organic light-emitting element completely covers the organic light-emitting element, as viewed from the top.

4. The organic electroluminescent apparatus according to claim 1, wherein the first sealing portion is separated from the second sealing portion, and the drying agent film surrounds the organic light-emitting element, as viewed from the top.

5. The organic electroluminescent apparatus according to claim 1, wherein the second substrate has a recessed portion in a region in which the drying agent film is to be formed in the closed space, and the drying agent film is formed in the recessed portion.

6. The organic electroluminescent apparatus according to claim 1, wherein the surface of the second substrate facing the closed space in a region in which the second sealing portion is formed is recessed relative to the surface of the second substrate facing the closed space in a region in which the first sealing portion is formed, and the second sealing portion has a larger thickness than the first sealing portion.

7. The organic electroluminescent apparatus according to claim 1, wherein a sealant of the first sealing portion is different from a sealant of the second sealing portion.

8. The organic electroluminescent apparatus according to claim 1, wherein a sealant of the first sealing portion contains a gap-forming material.

9. The organic electroluminescent apparatus according to claim 1, wherein the drying agent film is in contact with the first and second substrates.
